(19) United States
(12) Patent Application Publication
(10) Pub. No.: US 2012/0259554 A1
(43) Pub. Date: Oct. 11, 2012

(54) TONGUE TRACKING INTERFACE APPARATUS AND METHOD FOR CONTROLLING A COMPUTER PROGRAM

(75) Inventors: Ruxin Chen, Redwood city, CA (US); Ozlem Kalinli, Burlingame, CA (US)

(73) Assignee: Sony Computer Entertainment Inc., Tokyo (JP)

(21) Appl. No.: 13/083,260

(22) Filed: Apr. 8, 2011

(51) Int. Cl. G06F 19/00

(52) U.S. Cl. 702/19

(57) ABSTRACT

A tongue tracking interface apparatus for control of a computer program may include a mouthpiece configured to be worn over one or more teeth of a user of the computer program. The mouthpiece can include one or more sensors configured to determine one or more tongue orientation characteristics of the user. Other sensors such as microphones, pressure sensors, etc. located around the head, face, and neck, can also be used for determining tongue orientation characteristics.

### FIELD OF THE INVENTION

Embodiments of the present invention are directed to control interfaces for computer programs and more specifically to control interfaces that are controlled by the tongue.

### BACKGROUND OF THE INVENTION

There are a number of different control interfaces that may be used to provide input to a computer program. Examples of such interfaces include well-known interfaces such as a computer keyboard, mouse, or joystick controller. Such interfaces typically have analog or digital switches that provide electrical signals that can be mapped to specific commands or input signals that affect the execution of a computer program.

Recently, interfaces have been developed for use in conjunction with computer programs that rely on other types of input. There are interfaces based on microphones or microphone arrays, interfaces based on cameras or camera arrays, and interfaces based on touch. Microphone-based systems are used for speech recognition systems that try to supplant keyboard inputs with spoken inputs. Microphone array based systems can track sources of sound as well as interpret the sounds. Camera based interfaces attempt to replace joystick inputs with gestures and movements of a user or object held by a user. Touch based interfaces attempt to replace keyboards, mice, and joystick controllers as the primary input component for interacting with a computer program.

Different interfaces have different advantages and drawbacks. Keyboard interfaces are good for entering text, but less useful for entering directional commands. Joysticks and mice are good for entering directional commands and less useful for entering text. Camera-based interfaces are good for tracking objects in two-dimensions, but generally require some form of augmentation (e.g., use of two cameras or a single camera with echo-location) to track objects in three dimensions. Microphone-based interfaces are good for recognizing speech, but are less useful for tracking spatial orientation of objects. Touch-based interfaces provide more intuitive interaction with a computer program, but often experience latency issues as well as issues related to misinterpreting a user's intentions. It would be desirable to provide an interface that supplements some of the interfaces by analyzing additional characteristics of the user during interaction with the computer program.

It is within this context that embodiments of the present invention arise.

### BRIEF DESCRIPTION OF THE DRAWINGS

FIGS. 1A-1C are schematic diagrams illustrating a tongue tracking interface apparatus for control of a computer program according to an embodiment of the present invention.

FIGS. 2A-2B illustrate an alternative tongue tracking interface apparatus for control of a computer program according to an embodiment of the present invention.

FIGS. 3A-3B illustrate another alternative tongue tracking interface apparatus for control of a computer program according to an embodiment of the present invention.

FIGS. 4A-4F illustrate several alternative configurations for tongue tracking interface apparatus for control of a computer program according to embodiments of the present invention.

FIG. 5 illustrates an alternative tongue tracking interface apparatuses for control of a computer program according to an embodiment of the present invention.

FIG. 6 is a schematic/flow diagram illustrating a tongue tracking interface method for controlling a computer program.

FIG. 7 illustrates a block diagram of a computer apparatus that may be used to implement a tongue tracking interface method for controlling a computer program according to an embodiment of the present invention.

### FIELD OF THE INVENTION

Embodiments of the present invention are related to a tongue tracking interface apparatus and method for controlling a computer program.

### DESCRIPTION OF SPECIFIC EMBODIMENTS

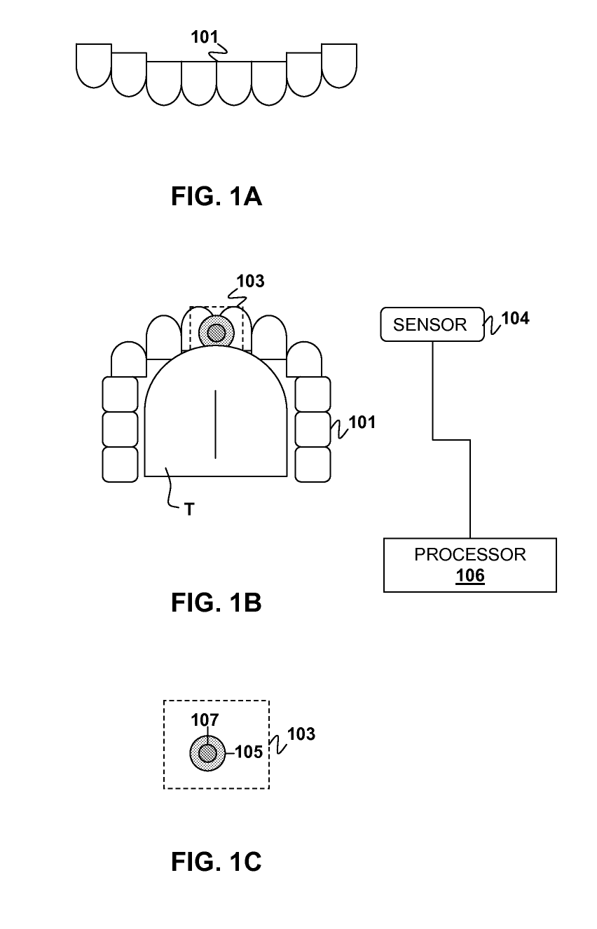

FIGS. 1A-C illustrate an example of a tongue tracking interface apparatus 101 that may be used for control of a computer program according to an embodiment of the present invention. In this particular embodiment, the tongue tracking interface apparatus 101 is a mouthpiece with a caged magnetic ball 103. FIG. 1A depicts a front view of the tongue tracking interface apparatus as perceived from outside of the user's mouth. FIG. 1B depicts a bottom-up view of the tongue tracking interface apparatus as perceived from the inside of the user's mouth. FIG. 1C provides a detailed view of the caged magnetic ball 103.

As illustrated, the mouthpiece 101 may be in the form of a mouth guard to be worn around the user's teeth during interaction with the computer program. However, it is important to note that the mouthpiece 101 may be in the form of dentures, a dental retainer, braces, tongue ring or any other tool that may be comfortably fixed within a user's mouth during interaction with the computer program. Furthermore, while only a single mouthpiece 101 is depicted in FIGS. 1A and 1B, the tongue tracking interface apparatus may be extended to include multiple mouthpieces to facilitate tracking of a user's tongue orientation characteristics.

The mouthpiece 101 includes a caged magnetic ball 103 located on the backside of the mouthpiece 101 configured so that the caged magnetic ball 103 sits behind the user's teeth when the mouthpiece 101 is worn. It is important to note that the caged magnetic ball 103 may be positioned in various locations of the mouthpiece 101 depending on the application involved.

The caged magnetic ball 103 includes a magnetized ball 107 positioned inside a cage 105 fixed to the mouthpiece 101, such that the ball may rotate freely within the confines of the cage 105. The behavior of the caged magnetic ball 103 may mimic that of a trackball found on commonly-used computer mice. The user's tongue T can manipulate the ball 103 within the cage. The magnetized ball 107 has an associated magnetic field that changes (e.g., change in direction, magnitude, polarization) when rotated. A magnetic sensor 104 located outside of the user's mouth in close proximity to the mouthpiece 101 may be configured to detect changes in the magnetized ball's 107 associated magnetic field. The sensor 104 may be coupled to a computer processor 106, which may be programmed to interpret the signals from the sensor 104. Certain movements of the magnetized ball 107 made by the user's tongue may lead to changes in its associated magnetic field that may then be analyzed to determine a corresponding tongue orientation characteristic associated with that particular movement. By way of example, and not by way of limitation, these tongue orientation characteristics may include: whether the tongue is moving to the left, right, up, or down; whether the tongue is rubbing against the teeth; whether the tongue is clicking forward or backward, or whether the tongue is rotating. The sensor 104 can detect these changes and send corresponding signals to the processor. Software running on the processor 106 can interpret the signals from the sensor as appropriate inputs.

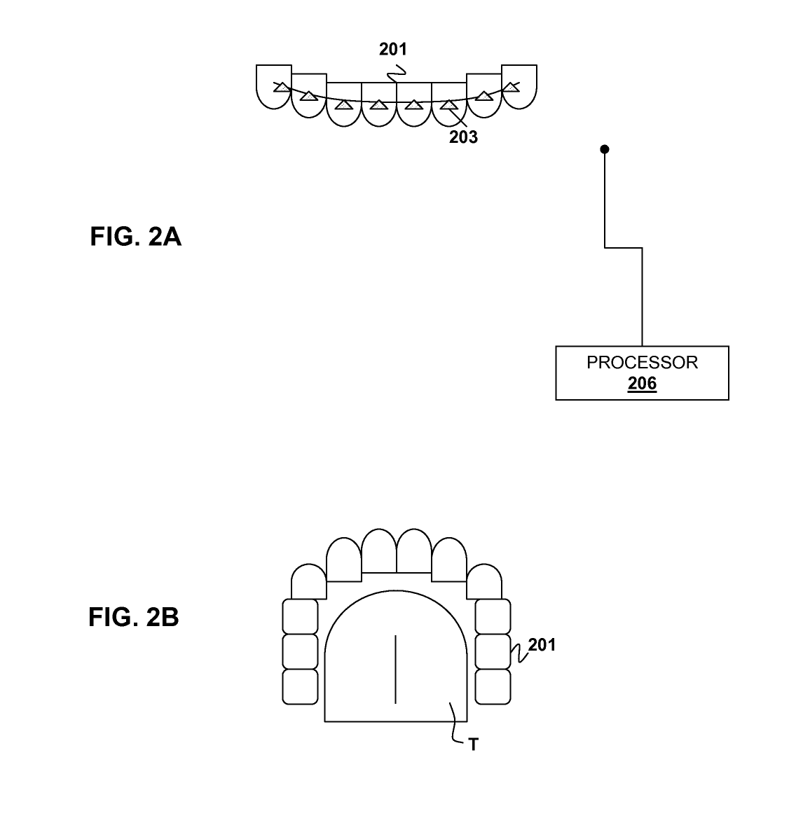

FIGS. 2A-B illustrate an alternative tongue tracking interface apparatus for control of a computer program according to an embodiment of the present invention. In this particular embodiment, the tongue tracking interface apparatus 201 is a mouthpiece with one or more pressure sensors or capacitor sensors 203 configured to track one or more tongue orientation characteristics of the user. Pressure sensors can generate a signal if the tongue touches them with sufficient pressure. Capacitor sensors can sense the presence of the tongue some distance before the tongue physically touches the sensors through a chance in capacitance due to the proximity of the tongue. FIG. 2A depicts a front view of the tongue tracking interface apparatus as perceived from outside of the user's mouth. FIG. 2B depicts a bottom-up view of the tongue tracking interface apparatus as perceived from the inside of the user's mouth.

Again, the mouthpiece 201 may be in the form of a mouth guard to be worn around the user's teeth during interaction with the computer program. However, as mentioned above, it is important to note that the mouthpiece 201 may be in the form of dentures, a dental retainer, braces, tongue ring or any other tool that may be comfortably fixed within a user's mouth during interaction with the computer program. Furthermore, while only a single mouthpiece 201 is depicted in FIG. 2A and 2B, the tongue tracking interface apparatus may be extended to include multiple mouthpieces to facilitate tracking of a user's tongue orientation characteristics.

The mouthpiece 201 includes one or more pressure sensors or capacitor sensors 203 located on the front side of the mouthpiece 201 configured so that the pressure sensors or capacitor sensors 203 sit in front of the user's teeth when the mouthpiece 201 is worn. It is important to note that any number of pressure sensors or capacitor sensors 203 may be situated on the mouthpiece depending on the application involved. Likewise, the pressure sensors or capacitor sensors 203 may be positioned at various locations on the mouthpiece 201 depending on the application involved.

The pressure sensors or capacitor sensors 203 essentially act as transducers, generating signals as a function of the pressure imposed. The signals can be coupled wirelessly to a processor 206. Certain movements made by the user's tongue may activate the pressure sensors or capacitor sensors 203 causing them to generate signals that may then be analyzed by the processor 206 to determine a corresponding tongue orientation characteristic associated with that particular movement of the user's tongue T.

By way of example, and not by way of limitation, these tongue orientation characteristics may include: whether the tongue is moving to the left, right, up, or down; whether the tongue is rubbing against the teeth; whether the tongue is clipping, or whether the tongue is rotating. By way of example, and not by way of limitation, the signal generated by the pressure sensor 203 corresponding to the movement of the user's tongue may be transmitted for analysis electromagnetically through the user's skin or by way of ultrasound.

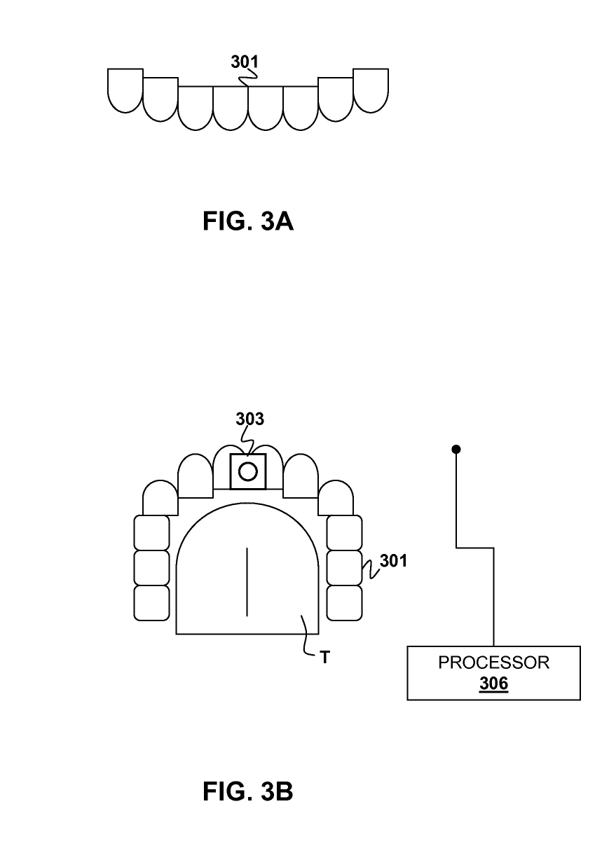

FIG. 3A-B illustrate yet another alternative tongue tracking interface apparatus for control of a computer program according to an embodiment of the present invention. In this particular embodiment, the tongue tracking interface apparatus 301 is a mouthpiece with a thermal camera 303 configured to track one or more orientation characteristics of the tongue T of the user. The thermal camera 303 may be wirelessly coupled to a processor 306. FIG. 3A depicts a front view of the tongue tracking interface apparatus as perceived from outside of the user's mouth. FIG. 3B depicts a bottom-up view of the tongue tracking interface apparatus as perceived from the inside of the user's mouth.

Again, the mouthpiece 301 illustrated is in the form of a mouth guard to be worn around the user's teeth during interaction with the computer program. However, as mentioned above, it is important to note that the mouthpiece 301 may be in the form of dentures, a dental retainer, braces, tongue ring or any other tool that may be comfortably fixed within a user's mouth during interaction with the computer program. Furthermore, while only a single mouthpiece 301 is depicted in FIG. 3A and 3B, the tongue tracking interface apparatus may be extended to include multiple mouthpieces to facilitate tracking of a user's tongue orientation characteristics.

In this embodiment, the mouthpiece 301 includes a thermal camera 303 located on the back side of the mouthpiece 301 configured so that the thermal camera 303 sits behind the user's teeth when the mouthpiece 301 is worn. It is important to note that any number of thermal cameras 303 may be situated on the mouthpiece depending on the application involved. Likewise, the thermal cameras 303 may be positioned at various locations on the mouthpiece 301 depending on the application involved.

The thermal camera 303 is configured to capture images using infrared radiation. All objects emit a certain amount of blackbody radiation as a function of their temperatures, and the thermal camera 303 is configured to capture such emitted blackbody radiation. Such thermal images capture by the thermal camera 303 may then be analyzed by the processor 306 to determine a corresponding tongue orientation characteristic associated with that particular thermal image. By way of example, and not by way of limitation, these tongue orientation characteristics may include: whether the tongue is moving to the left, right, up, or down; whether the tongue is rubbing against the teeth; whether the tongue is clipping, or whether the tongue is rotating. By way of example, and not by way of limitation, the image captured by the thermal camera 303 corresponding to the movement of the user's tongue may be transmitted for analysis electromagnetically through the user's skin or by way of ultrasound.

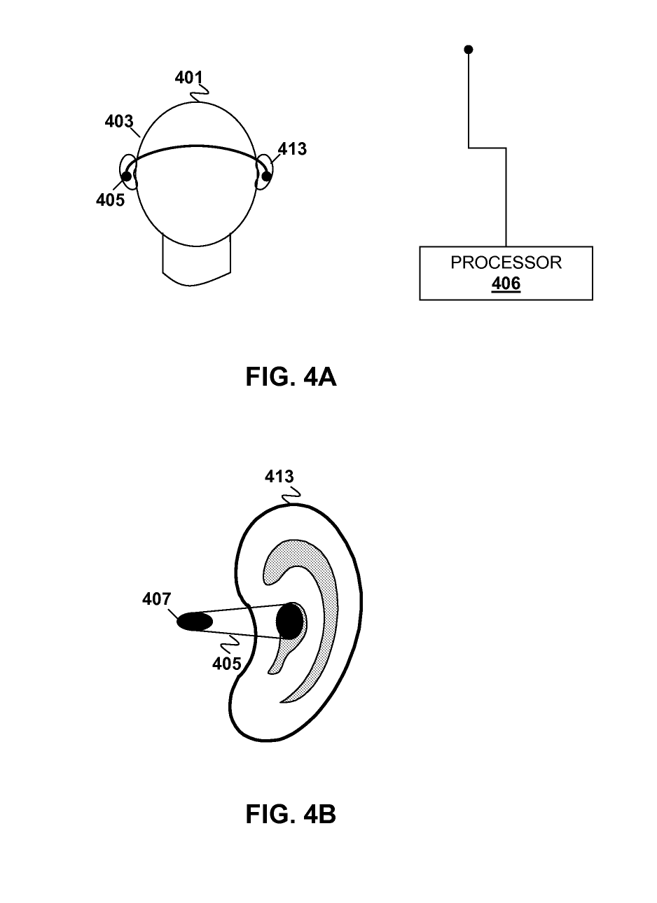

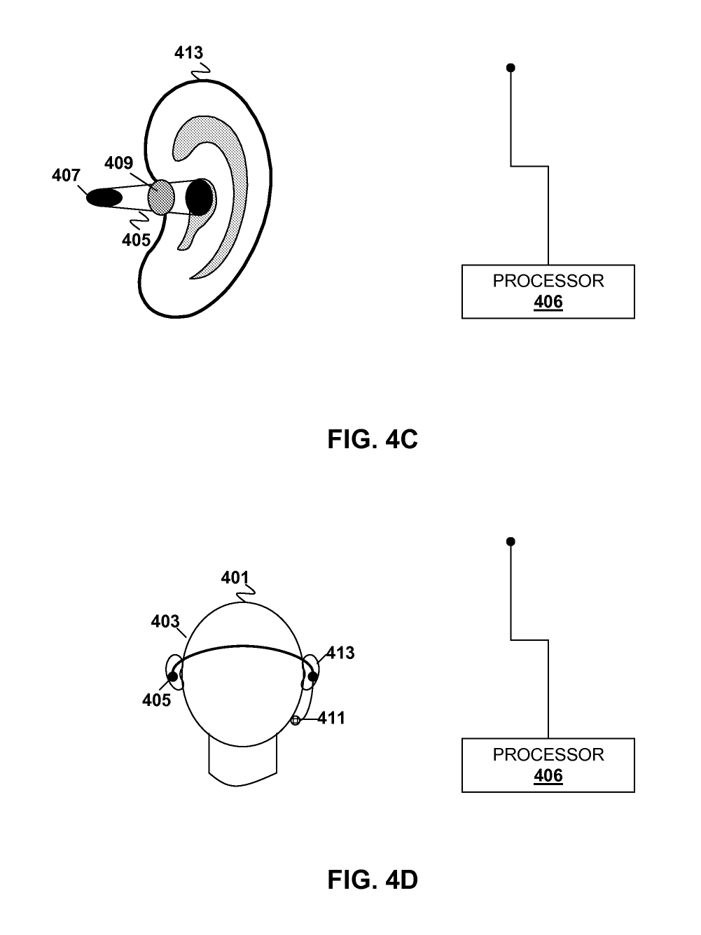

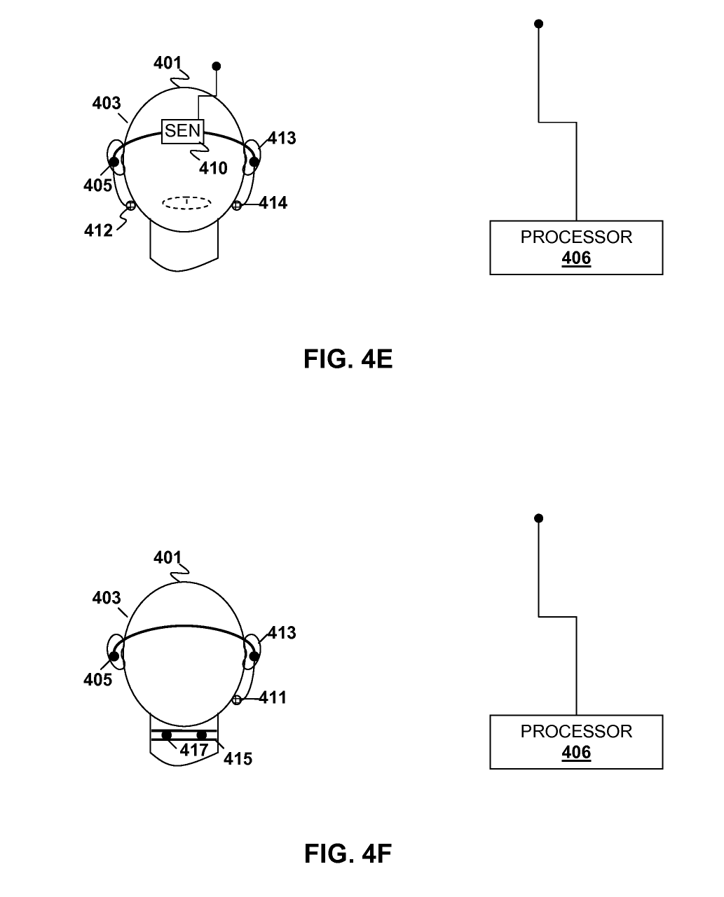

FIGS. 4A-E illustrate several alternative tongue tracking interface apparatuses for control of a computer program according to an embodiment of the present invention. In these particular embodiments, the tongue tracking interface apparatus makes use of a headset 403 to be worn by the user 401 during interaction with a computer program. The headset 403 includes one or more sensors configured to track one or more tongue orientation characteristics of the user 401. The headset 403 can be coupled to a processor 406, e.g., by wireless connection, such as a radiofrequency personal area network connection. The implementation and configuration of these sensors will be discussed in further detail below.

FIGS. 4A-4B illustrate a first tongue tracking interface apparatus that involves a headset 403. FIG. 4A illustrates the headset 403 as worn by the user 401 during interaction with the computer program. The headset 403 includes two earphones 405 to be inserted into the ears 413 of the user 401 during interaction with the computer program. FIG. 4B provides a more detailed view of the earphone 405 as it is positioned in the user's ear 413.

Each earphone 405 contains a microphone 407 located at the tip to be inserted in the user's ear 413. These microphones 407 are configured to detect sound corresponding to movement of the user's 401 tongue. The statistical characteristic of the sound will be mapped to a particular tongue orientation characteristic of the user (e.g., whether the tongue is moving to the left, right, up, or down, etc.). While each earphone 405 in our example includes only a single microphone 407 at the tip, the microphone 407 could easily be replaced with a microphone array to improve performance in analyzing the sound.

FIG. 4C illustrates an alternative configuration of the tongue tracking interface apparatus described above with respect to FIG. 4A and FIG. 4B. To help supplement analysis of sound generated by the user's ears 413, an additional stethoscope acoustic sensor 409 may be included in the center of each earphone 405. The stethoscope acoustic sensor 409 is configured to detect sound generated by the user's jaw while the earphone 405 is inserted into the user's ear 413. A heart beat signal could be detected and used to either enhance touch movement detection or used in combination with tongue movement to provide additional control of the processor 406. The detected heart beat signal can be used to remove the heartbeat from the input signal from the acoustic sensor 409 so that detection of tongue movement can be enhanced. The sound from the user's jaw may then be analyzed to help supplement analysis of sound from the user's tongue. The user's jaw movement may provide additional information to aid in more accurately determining the user's one or more tongue orientation characteristics during interaction with the computer program. By way of example, and not by way of limitation, the statistical characteristics of the sound made by the user's tongue and the sound made by the user's jaw may be combined and then subsequently mapped to a particular tongue orientation characteristic of the user

Alternatively, the tongue tracking interface apparatus described above with respect to FIG. 4A and FIG. 4B could be supplemented using a microphone located at a contact point between the headset and the user's mouth as illustrated in FIG. 4D. The microphone 411 may be connected to the headset as a separate component, independent of the earphones 405. While our example includes only a single contact point microphone 411, the contact point microphone 411 could easily be replaced with a microphone array to improve performance in analyzing the sound.

Alternatively, the tongue can be modeled as a dipole in which the anterior pole is positive and the posterior pole is negative. Then the tongue is the origin of a steady electric potential field. The corresponding electrical signal can be measured using a pair of electrodes placed on the skin proximate the tongue T, e.g., as shown in FIG. 4E. The electrodes may be mounted to a headset and coupled to an electric field sensor 410. By way of example, and not by way of limitation, first and second electrodes 412, 414 may be placed at the opposite sides of cheeks. Alternatively, the electrodes may be located below and above the lips, etc. If the tongue T moves from the centre position towards right, this change in dipole orientation causes a change in electric potential field and thus the measured electrical signal amplitude. The electrical signal amplitude (or change in signal amplitude) may be transmitted from the sensor to the processor 406, e.g., by wireless transceiver. By analyzing these changes in the measured electrical signal amplitude, tongue movement can be tracked.

One or more electrodes can be used to track tongue movements horizontally and vertically. The electrodes can be designed so that they are wearable. For example, the person can wear a headset like that shown in FIG. 4D with one sensor 412 on the left cheek touching the skin and one electrode 414 on the right cheek touching the skin. Similarly groups of two or more electrodes may be placed on either side of the cheeks such that one electrode touches to the skin at lower part of cheeks and one electrode touches to the skin at upper part of cheeks. The sensor 410 can interpret measured electrical signals from multiple electrodes and estimate tongue movement; e.g., whether the tongue is moving up/down, left/right, or at an intermediate angle, etc. Alternatively, the sensor 410 can transmit the measured electrical signals to the processor 406, where the measured electrical signals are analyzed to track tongue movement.

The tongue tracking interface apparatus described above with respect to FIG. 4A and B could alternatively be supplemented by a necklace configured to detect sound generated by the user's throat during interaction with the computer program as illustrated in FIG. 4F. The necklace 415 is configured to be worn around the user's neck during interaction with the computer program. The necklace 415 includes one or more microphones 417 that are configured to detect sound generated by movement of the user's neck. The sound from the user's neck may then be analyzed by suitable software running on the processor 406 to help supplement analysis of sound from the user's tongue. The user's neck movement may provide additional information to aid in more accurately determining the user's one or more tongue orientation characteristics during interaction with the computer program. The neck movement itself could be used in combination with the tongue's movement to provide the control signal to the processor 406. By way of example, and not by way of limitation, the statistical characteristics of the sound made by the user's tongue and the sound made by the user's neck may be combined and then subsequently mapped to a particular tongue orientation characteristic of the user. While our example includes only two microphones 417 on the necklace 415, the necklace 415 may be adapted to include any number of microphones in any number of locations depending on the application.

In some embodiments, the necklace 415 can also include pressure sensors, which can be located on either side of the throat. The pressure sensors can provide pressure signals that can be mapped to corresponding orientation characteristics of the tongue. By way of example, when the tongue moves, the pressure sensors on the right and left sides of throat can measure differences in pressure caused by tongue movement. The differences in pressure can be mapped to tongue orientation characteristics. It is further noted that embodiments of the invention include implementations involving combination of microphones and pressure sensors.

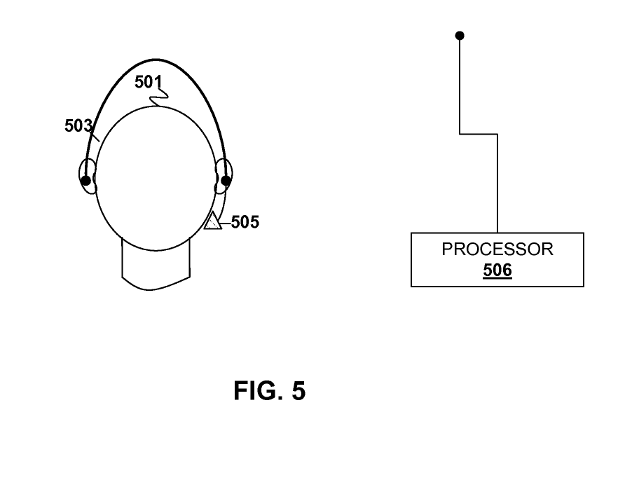

FIG. 5 illustrates an alternative tongue tracking interface apparatuses for control of a computer program according to an embodiment of the present invention. In this particular embodiment, the tongue tracking interface apparatus makes use of a headset 503 to be worn by the user 501 during interaction with a computer program. The headset may be coupled to a processor 506, e.g., by a wireless or wired connection.

The headset 503 is configured to be worn by the user 501 during interaction with the computer program. The headset 503 includes a sensor 505 configured to determine one or more tongue orientation characteristics of the user during interaction with the computer program. By way of example and not by way of limitation, this sensor may be realized as a Bluetooth sensor, infrared sensor, or ultrasound sensor.

A Bluetooth sensor may sense tongue orientation characteristics of the user by sending Bluetooth signals through the mouth, and analyzing the reflected signal to determine which tongue orientation characteristics (e.g., whether the tongue is moving to the left, right, up, or down, etc.) are present on the user.

An infrared sensor may perform similarly by sending infrared signals through the mouth and then subsequently analyzing the reflected signals to determine which orientation characteristics are present on the user. Alternatively, the infrared sensor may capture an infrared image of the user's mouth profiling the blackbody radiation emitted from various locations within the user's mouth. This image may then be analyzed by the processor 506 to determine the presence of certain tongue orientation characteristics of the user.

The ultrasound sensor may operate by first sending a sound wave through the user's mouth. The sound wave is then partially reflected from the layers between different tissues. The ultrasound sensor may capture some of these reflections, and then analyze them to create a digital image of the inside of the user's mouth. By way of example, and not by way of limitation, the reflected sound waves may be analyzed to determine the length of time between transmission and receipt and the magnitude of the reflected sound wave. From this information, the ultrasound sensor may create a digital image of the inside of the user's mouth which may subsequently be used by the processor 506 to determine the presence of certain tongue orientation characteristics of the user.

While only a single sensor 505 is shown in FIG. 5, additional sensors could be easily added at different locations around the user's mouth to facilitate determination of the user's tongue orientation characteristics.

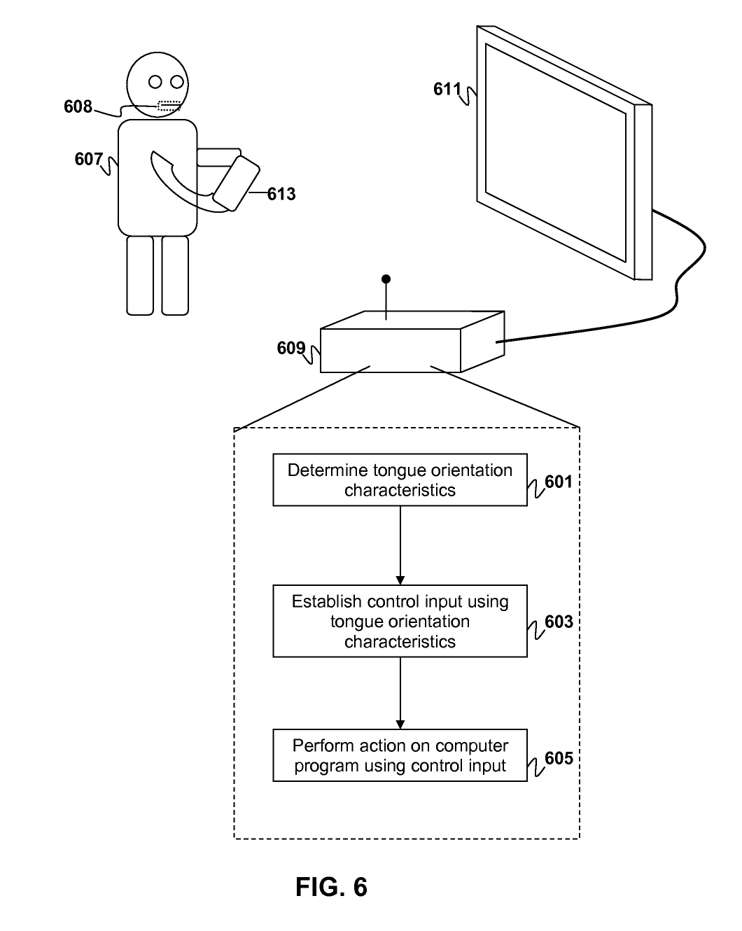

FIG. 6 is a schematic/flow diagram illustrating a tongue tracking interface method for controlling a computer program. A user 607 may interact with a computer program running on an electronic device 609. By way of example, the electronic device may include a computer processor that executes the program. Examples of suitable electronic devices include computers, laptop computers, video game consoles, digital cameras, digital televisions, cellular phones, and wheelchairs, electronic toys including toy airplanes, robots, musical instruments, audio speakers, and the like. It is further noted that tongue movement can be mapped, e.g., by a lookup table, to corresponding sounds, which may be pre-recorded or synthesized in a pre-determined manner. Consequently, sounds, including vocal sounds, may be directly generated from tongue movement even if the user's mouth is never opened. Similarly, tongue movement mapped to corresponding sounds can directly be converted into text, which can be fed into the electronic devices. This in effect allows speech recognition to be implemented through mapping of tongue movement to units of speech instead of mapping acoustic signals.

By way of example and not by way of limitation, the computer program may be a video game running on a video game system. The device 609 may be operably connected to a visual display 611 configured to display contents of the computer program to facilitate interaction between the user 607 and the computer program. The user 607 may communicate with the computer program through a user interface apparatus 613. By way of example and not by way of limitation, the user interface apparatus 613 may be a keyboard, controller, joystick, steering wheel, etc. The user 607 may also be wearing a tongue tracking interface apparatus 608, which may be configured as described above with respect to FIGS. 1A-1C, FIGS. 2A-2B, FIGS. 3A-3B, FIGS. 4A-4E, and FIG. 5.

During interaction with the computer program, the tongue tracking interface apparatus may determine one or more tongue orientation characteristics of the user as illustrated at 601. The tongue tracking interface apparatus may determine the one or more tongue orientation characteristics in accordance with any of the methods discussed above with respect to the tongue tracking interface apparatus described with respect to FIGS. 1A-1C, FIGS. 2A-2B, FIGS. 3A-3B, FIGS. 4A-4E, and FIG. 5. By way of example, and not by way of limitation, these tongue orientation characteristics may include: whether the tongue is moving to the left, right, up, or down; whether the tongue is rubbing against the teeth; whether the tongue is clipping, or whether the tongue is rotating.

Once the user's one or more tongue orientation characteristics have been determined, a control input may be established for the computer program using the orientation characteristics determined as illustrated at 603. For example, if the user's tongue is moving to the right, a control input that corresponds to moving an object in the virtual environment created by the computer program to the right may be established.

After the control input has been established, the computer program may perform an action based on the control input as illustrated at 605. By way of example, and not by way of limitation, this action may be the movement of an object associated with a virtual environment created by the computer program.

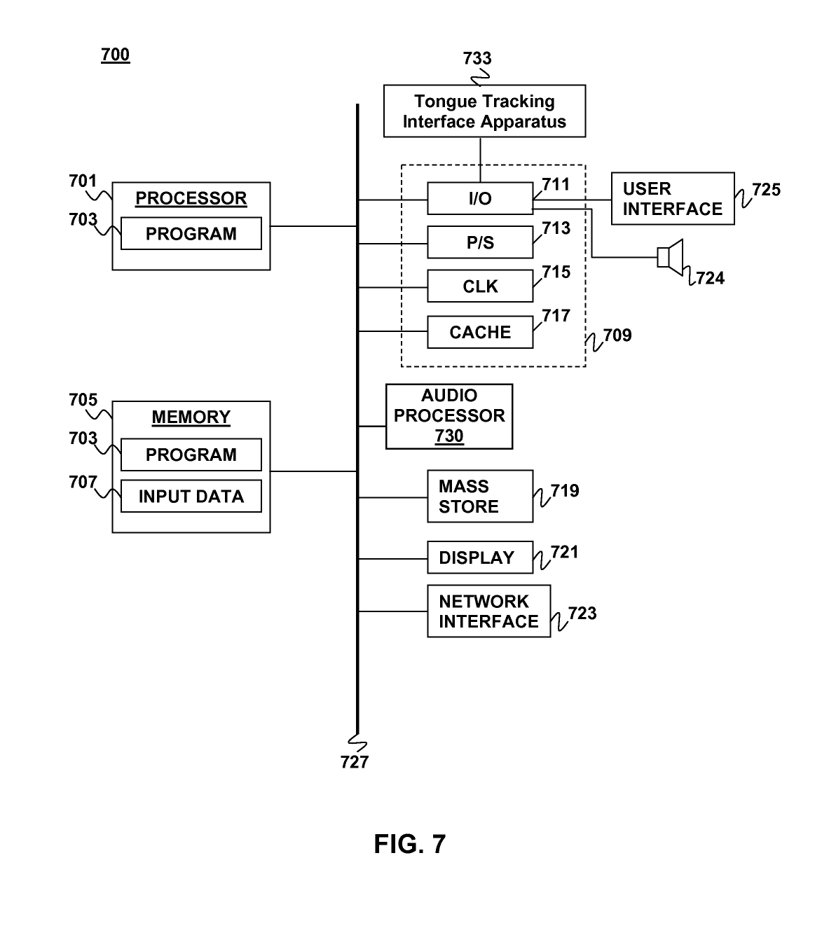

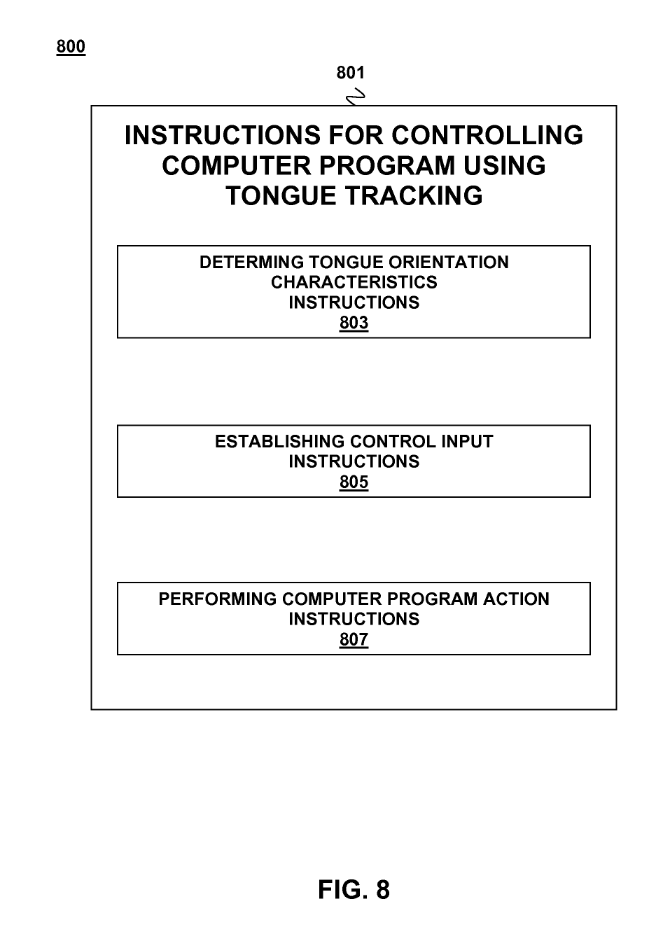

FIG. 7 illustrates a block diagram of a computer apparatus that may be used to implement a tongue tracking interface method for controlling a computer program according to an embodiment of the present invention. The apparatus 700 generally may include a processor module 701 and a memory 705. The processor module 701 may include one or more processor cores. An example of a processing system that uses multiple processor modules, is a Cell Processor, examples of which are described in detail, e.g., in Cell Broadband Engine Architecture, which is available online at http://www-306.ibm.com/chips/techlib/techlib.nsf/techdocs/1AEEE1270EA2776387357060006E61BA/$file/CBEA_{—}01_pub.pdf, which is incorporated herein by reference.

The memory 705 may be in the form of an integrated circuit, e.g., RAM, DRAM, ROM, and the like. The memory 705 may also be a main memory that is accessible by all of the processor modules. In some embodiments, the processor module 701 may have local memories associated with each core. A program 703 may be stored in the main memory 705 in the form of processor readable instructions that can be executed on the processor modules. The program 703 may be configured to implement a tongue tracking interface method for controlling a computer program. The program 703 may be written in any suitable processor readable language, e.g., C, C++, JAVA, Assembly, MATLAB, FORTRAN, and a number of other languages. Input data 707 may also be stored in the memory. Such input data 707 may include determined tongue orientation characteristics of the user. During execution of the program 703, portions of program code and/or data may be loaded into the memory or the local stores of processor cores for parallel processing by multiple processor cores.

The apparatus 700 may also include well-known support functions 709, such as input/output (I/O) elements 711, power supplies (P/S) 713, a clock (CLK) 715, and a cache 717. The apparatus 700 may optionally include a mass storage device 719 such as a disk drive, CD-ROM drive, tape drive, or the like to store programs and/or data. The device 700 may optionally include a display unit 721 and user interface unit 725 to facilitate interaction between the apparatus 700 and a user. The display unit 721 may be in the form of a cathode ray tube (CRT) or flat panel screen that displays text, numerals, graphical symbols, or images. The user interface 725 may include a keyboard, mouse, joystick, light pen, or other device that may be used in conjunction with a graphic user interface (GUI). The apparatus 700 may also include a network interface 723 to enable the device to communicate with other devices over a network, e.g., a local area network, a personal area network, such as a Bluetooth® network, or a wide area network, such as the internet.

To facilitate generation of sounds, the apparatus 700 may further include an audio processor 730 adapted to generate analog or digital audio output from instructions and/or data provided by the processing module 701, memory 705, and/or storage 719. The audio output may be converted to audible sounds, e.g., by a speaker 724, which may be coupled to the I/O elements 711.

One or more tongue tracking interface apparatuses 733 may be connected to the processor module 701 via the I/O elements 711. As discussed above, these tongue tracking interface apparatuses 733 may be configured to determine one or more tongue orientation characteristics of a user in order to facilitate control of a computer program running on the device 700. The tracking interface maybe configured as described above with respect to FIGS. 1A-1C, FIGS. 2A-2B, FIGS. 3A-3B, FIGS. 4A-4E or FIG. 5. The tongue tracking interface apparatus 733 may be coupled to the I/O elements via a suitably configured wired or wireless link. In some embodiments, the tongue tracking interface 733 may alternatively be coupled to the processor 701 via the network interface 723.

The components of the system 700, including the processor 701, memory 705, support functions 709, mass storage device 719, user interface 725, network interface 723, and display 721 may be operably connected to each other via one or more data buses 727. These components may be implemented in hardware, software, firmware, or some combination of two or more of these.

According to another embodiment, instructions for controlling a device using tongue tracking and the statistical behavior of one specific user's tongue movement may be stored in a computer readable storage medium. By way of example, and not by way of limitation, FIG. 8 illustrates an example of a non-transitory computer readable storage medium 800 in accordance with an embodiment of the present invention. The storage medium 800 contains computer-readable instructions stored in a format that can be retrieved, interpreted, and executed by a computer processing device. By way of example, and not by way of limitation, the computer readable storage medium 800 may be a computer-readable memory, such as random access memory (RAM) or read only memory (ROM), a computer readable storage disk for a fixed disk drive (e.g., a hard disk drive), or a removable disk drive. In addition, the computer-readable storage medium 800 may be a flash memory device, a computer-readable tape, a CD-ROM, a DVD-ROM, a Blu-Ray, HD-DVD, UMD, or other optical storage medium.

The storage medium 800 contains instructions for controlling a computer program using tongue tracking instructions 801 configured to control a computer program using a tongue tracking interface apparatus. The instructions for controlling a computer program using tongue tracking 801 may be configured to implement control of a computer program using tongue tracking in accordance with the method described above with respect FIG. 6. In particular, the instructions for controlling a computer program using tongue tracking 801 may include determining tongue orientation characteristics instructions 803 that are used to determine one or more tongue orientation characteristics of a user while the user is interacting with the computer program. The determination of tongue orientation characteristics may be accomplished using any of the implementations discussed above.

The instructions for controlling a computer program using tongue tracking 801 may also include establishing control input instructions 805 that are used to establish one or more control inputs for the computer program based on the one or more tongue orientation characteristics determined. The control input inputs may be used to instruct the computer program to manipulate an object in a virtual environment associated with the computer program, as discussed above.

To utilize the control inputs established by the control input instructions 805, the instructions for controlling a computer program using tongue tracking 801 may additionally include performing computer program action instructions 807 that instruct the computer program to perform one or more actions in accordance with the established control inputs. By way of example, and not by way of limitation, these instructions may implement a look-up table that correlates a established control inputs to corresponding actions to be implemented by the computer program. Each action may be implemented by executing a corresponding set program code instructions.

While the above is a complete description of the preferred embodiment of the present invention, it is possible to use various alternatives, modifications, and equivalents. Therefore the scope of the present invention should be determined not with reference to the above description, but should, instead, be determined with reference to the appended claims, along with their full scope of equivalents. Any feature described herein, whether preferred or not, may be combined with any other feature described herein, whether preferred or not. In the claims that follow, the indefinite article “A” or “An” refers to a quantity of one or more of the item following the article, except where expressly stated otherwise. The appended claims are not to be interpreted as including means-plus-function limitations, unless such a limitation is explicitly received in a give claim using the phrase “means for”.

What is claimed is:

1. A tongue tracking interface apparatus for control of a computer program, comprising:
a mouthpiece configured to be worn over one or more teeth of a user of the computer program, the mouthpiece including one or more sensors configured to determine one or more tongue orientation characteristics of the user.

2. The apparatus of claim 1, wherein the one or more sensors include a caged magnetic ball that may be manipulated with the user's tongue, the caged magnetic ball having an associated magnetic field.

3. The apparatus of claim 1, wherein the one or more sensors include a pressure sensor.

4. The apparatus of claim 1, wherein the one or more sensors include a thermal camera.

5. A tongue tracking interface apparatus for control of a computer program, comprising: a headset to be worn by a user of the computer program, the headset including one or more sensors configured to determine one or more tongue orientation characteristics of the user.

6. The tongue tracking interface apparatus of claim 5, wherein the one or more sensors include two microphones, each microphone being located on the tip of a corresponding earphone of the headset, the microphones being configured to determine one or more tongue orientation characteristics of the user.

7. The tongue tracking interface apparatus of claim 6, further comprising two stethoscope acoustic sensors, each stethoscope acoustic sensor being located at the center of a corresponding earphone, the stethoscope acoustic sensors being configured to detect sound generated by movement of the user's jaw.

8. The tongue tracking interface apparatus of claim 6, further comprising one or more additional microphones, the additional microphones being located at a contact point between the headset and the user's chin, the microphone being configured to detect sound generated by movement of the user's jaw.

9. The tongue tracking interface apparatus of claim 5, wherein the one or more sensors includes an ultrasound sensor, the ultrasound sensor being configured to capture one or ultrasound signals from the user's mouth.

10. The tongue tracking interface apparatus of claim 5, wherein the one or more sensors includes an infrared sensor, the infrared sensor being configured to capture one or more infrared signals from the user's mouth.

11. The tongue tracking interface apparatus of claim 5, wherein the one or more sensors includes a Bluetooth sensor, the Bluetooth sensor being configured to determine one or more tongue orientation characteristics of the user.

12. The tongue tracking interface apparatus of claim 5, further comprising a necklace to be worn around a neck of the user, the necklace including one or more sensors configured to detect sound generated by movement of the user's jaw, neck, or throat.

13. The tongue tracking interface apparatus of claim 12, wherein the one or more sensors includes a microphone, the microphone being configured to detect sound generated by movement of the user's jaw, neck, or throat.

14. The tongue tracking interface apparatus of claim 12, wherein the one or more sensors includes a pressure sensor, the pressure sensor being configured to detect pressure generated by movement of the user's jaw, neck, or throat.

15. The tongue tracking interface apparatus of claim 1, wherein the one or more sensors are configured to detect a change in electric field of the tongue resulting from movement of the tongue.

16. A tongue tracking interface method for control of a computer program, comprising:
a) determining one or more tongue orientation characteristics of a user of the computer program; and
b) establishing a control input for the computer program using the one or more tongue orientation characteristics determined in a).

17. The method of claim 16, wherein determining one or more tongue orientation characteristics in a) involves using a pressure sensor attached to a dental retainer worn by the user.

18. The method of claim 16, wherein determining one or more tongue orientation characteristics in a) involves using a thermal camera attached to a dental retainer worn by the user.

19. The method of claim 16, wherein determining one or more tongue orientation characteristics in a) involves using a magnetic ball attached to a dental retainer worn by the user and external magnetic sensors.

20. The method of claim 16, wherein determining one or more tongue orientation characteristics in a) involves using a dental retainer worn by the user and one or more microphones.

21. The method of claim 16, wherein determining one or more tongue orientation characteristics in a) involves using two microphones, each microphone being located on the tip of an earphone to be inserted into the user's ears.

22. The method of claim 21, wherein determining one or more tongue orientation characteristics in a) further comprises using two acoustic sensors, each acoustic sensor being located in the middle of the earphone to be inserted into the user's ears, the acoustic sensors being configured to process sound generated by the user's jaws, the sound generated by the user's jaws providing supplemental data to facilitate determination of the one or more tongue orientation characteristics.

23. The method of claim 16, wherein determining one or more tongue orientation characteristics in a) involves using one or more microphones, each microphone being located in close proximity to the user's mouth.

24. The method of claim 16, wherein determining one or more tongue orientation characteristics in a) involves using an ultrasound device located in close proximity to the user's mouth.

25. The method of claim 16, wherein determining one or more tongue orientation characteristics in a) involves using an infrared sensor located in close proximity to the user's mouth.

26. The method of claim 16, wherein determining one or more tongue orientation characteristics in a) involves using a Bluetooth sensor in close proximity to the user's mouth.

27. The method of claim 16, wherein determining one or more tongue orientation characteristics in a) further includes determining one or more corresponding throat orientation characteristics of the user using one or more microphones placed on the user's throat, the one or more corresponding throat orientation characteristics providing supplemental data to facilitate determination of the one or more tongue orientation characteristics.

28. The method of claim 16, wherein determining one or more tongue orientation characteristics in a) further includes determining one or more corresponding throat orientation characteristics of the user using one or more pressure sensors placed on the user's throat, the one or more corresponding throat orientation characteristics providing supplemental data to facilitate determination of the one or more tongue orientation characteristics.

29. The method of claim 16, wherein determining one or more tongue orientation characteristics in a) includes determining whether the tongue is moving up, down, to the left, or to the right.

30. The method of claim 16, wherein determining one or more tongue orientation characteristics in a) includes determining whether the tongue is rubbing against teeth.

31. The method of claim 16, wherein determining the one or more tongue orientation characteristics in a) includes determining whether the tongue is clipping.

32. The method of claim 16, wherein determining one or more tongue orientation characteristics in a) includes determining whether the tongue is rotating.

33. The method of claim 16, wherein establishing a control input for the computer program includes using a history of the user's past tongue activity.

34. The method of claim 16, wherein determining one or more tongue orientation characteristics includes detecting a change in an electric field of the tongue resulting from movement of the tongue.

35. An apparatus for control of a computer program, comprising:
a tongue tracking interface apparatus;
a processor operably coupled to the tongue tracking interface apparatus;
a memory; and
computer-coded instructions embodied in the memory and executable by the processor, wherein the computer coded instructions are configured to implement a tongue tracking interface method for control of a computer program, the method comprising:
a) determining one or more tongue orientation characteristics of a user of the computer program using the tongue tracking interface apparatus; and
b) establishing a control input for the computer program using the one or more tongue orientation characteristics determined in a).

36. A computer program product, comprising:
a non-transitory, computer-readable storage medium having computer readable program code embodied in said medium for implementing a tongue tracking interface method for control of a computer program, said computer program product having:
a) computer readable program code means for determining one or more tongue orientation characteristics of a user of the computer program; and
b) computer readable program code means for establishing a control input for the computer program using the one or more tongue orientation characteristics determined in a).
